(19) United States
(12) Patent Application Publication
(10) Pub. No.: US 2018/0003483 A1
(43) Pub. Date: Jan. 4, 2018

(54) DETECTION APPARATUS FOR A DISPLAY PANEL COMPONENT AND METHOD FOR DETECTING A DISPLAY PANEL COMPONENT

(71) Applicant: BOE TECHNOLOGY GROUP CO., LTD., Beijing (CN)

(72) Inventors: Junguo LIU, Beijing (CN); Shenglin SUN, Beijing (CN); Kang ZHENG, Beijing (CN); Hui LI, Beijing (CN)

(21) Appl. No.: 15/522,541

(22) PCT Filed: Jan. 11, 2016
(86) PCT No.: PCT/CN2016/070593

§ 371 Date: Apr. 27, 2017

(30) Foreign Application Priority Data
Aug. 28, 2015 (CN) 201510543412.4

(51) Int. Cl. G01B 11/14

(52) U.S. Cl. CPC G01B 11/14

(57) ABSTRACT

The present disclosure provides a detection apparatus for a display panel component and a method for detecting a display panel component, the detection apparatus of the display panel component including a reflectance measuring device for measuring the light reflectance of the display panel component along a preset path, the preset path passing through a first position and a second position, and a distance measuring device for acquiring a distance between the first position and the second position according to the measured data of the reflectance measuring device, wherein there is a light reflectance abrupt change in the first position and the second position, respectively.

### CROSS REFERENCE TO RELATED APPLICATIONS

This application is a National Stage Entry of PCT/CN2016/070593 filed Jan. 11, 2016, which claims the benefit and priority of Chinese Patent Application No. 201510543412.4, filed on Aug. 28, 2015, the disclosures of which are incorporated by reference herein in their entirety as part of the present application.

### BACKGROUND

The present disclosure relates to the display field, and particularly to a detection apparatus for a display panel component and a detection method for a display panel component.

Liquid crystal display panel (TFT-LCD), with the advantages of high display quality, low power consumption and no radiation, has been developed rapidly in recent years and has been widely used in various fields. The existing liquid crystal display panel mainly includes an array substrate, a color film substrate, and a liquid crystal layer. In the existing liquid crystal display panel manufacturing process, it is necessary to coat one layer of alignment film on the color film substrate and the array substrate (TFT substrate), and form an alignment groove on the alignment film to align and rotate liquid crystal molecules for the transmission of light, so as to implement the displaying thereof.

The existing alignment film coating process mainly adopts APR plate transfer printing technique to coat alignment liquid on the substrate. However, in the curing process of the alignment liquid, an area with uneven thickness is formed at the edge of the alignment liquid. To ensure even thickness of the display area on the substrate and image display quality, it is necessary to manually test the coating effect after the coating is completed. To ensure that the effective area of a panel is completely coated with the alignment film and that the distance from the area of uneven thickness to the display area on the substrate is greater than a preset distance (for example, 0.1 mm), the conventional alignment film coating effect detection method is specifically to measure the distance to the edge of the alignment film by imaging the display screen by the man-made moving of lens under a microscope. However, since the above detection method mainly adopts manual detection, it cannot achieve automated operations and is not conducive to the improvement of production capacity.

In other fields of the display panel, there are similar component detection problems.

### BRIEF DESCRIPTION

The present disclosure provides a solution for the automated detection of the coating effect of the alignment film.

In one aspect, the technical solution of the present disclosure provides a detection apparatus of a display panel component, including a reflectance measuring device for measuring the light reflectance of the display panel component along a preset path, the preset path passing through a first position and a second position, and a distance measuring device for acquiring a distance between the first position and the second position according to measured data of the reflectance measuring device, wherein there is a measured light reflectance abrupt change in the first position and the second position, respectively.

In one embodiment, the display panel component is a substrate having an alignment film and a display area, the first position being an edge of the display area, the second position being an edge of the alignment film.

Alternatively, the reflectance measuring device includes a light emitting unit for emitting incident light to a position on the preset path, a light receiving unit for receiving reflected light from the position on the preset path, and a light analyzing unit for obtaining a light reflectance of the position on the preset path according to the incident light and the reflected light.

Alternatively, the detection apparatus further includes a microscope lens.

Alternatively, the light emitting unit is integrated in the microscope lens.

Alternatively, a moving mechanism is further included for controlling the movement of the substrate.

Alternatively, the distance measuring device includes a timing unit for recording a first time and a second time, the first time being the time when a first light reflectance abrupt change is measured, the second time being the time when a second light reflectance abrupt change is measured, and a first distance calculating unit for calculating a distance between the first position and the second position according to the first time, the second time, and the moving speed of the substrate.

Alternatively, the distance measuring device includes a position acquiring unit for recording a first coordinate position and a second coordinate position, wherein the first coordinate position is a first coordinate position of the substrate where the first light reflectance abrupt change is measured, and the second coordinate position is a second coordinate position of the substrate where the second light reflectance abrupt change is measured, and a second distance calculating unit for calculating a distance between the first position and the second position according to the first coordinate position and the second coordinate position.

Alternatively, the detecting device further includes a data processing device including an information generating unit for recording the distances at different positions acquired from measured data of different preset paths and generating a corresponding data file.

Alternatively, the data processing device further includes an alarm unit for alarming if the distance exceeds a preset value range.

Alternatively, the substrate is an array substrate, and the edge of the display area is the edge of the outermost gate line on the array substrate facing away from the center of the array substrate or the edge of the outermost data line on the array substrate facing away from the center of the array substrate.

In another aspect, the technical solution of the present disclosure provides a method for detecting a display panel component, including measuring a light reflectance of the display panel component along a preset path, the preset path passing through a first and second position, and acquiring a distance between the first position and the second position according to the measured data of the reflectance, wherein there is a measured light reflectance abrupt change in the first position and the second position, respectively.

In one embodiment, the display panel component is a substrate coated with an alignment film, the first position is the edge of a display area on the substrate, and the second position is the edge of the alignment film. The light reflectance is measured by a reflectance measuring device and the distance is measured by a distance measuring device.

Alternatively, the reflectance measuring device includes a light emitting unit to emit incident light to a position on the preset path, a light receiving unit to receive reflected light from the position on the preset path, and a light analyzing unit to obtain a light reflectance at the position on the preset path according to the incident light and the reflected light.

Alternatively, the method further includes providing a moving mechanism to control the movement of the substrate.

Alternatively, the distance measuring device includes a timing unit for recording a first time and a second time, the first time being the time when a first light reflectance abrupt change is measured, the second time being the time when a second light reflectance abrupt change is measured, and a first distance calculating unit to calculate a distance between the first position and the second position according to the first time, the second time, and the moving speed of the substrate.

Alternatively, the distance measuring device further includes a position acquiring unit to record a first coordinate position and a second coordinate position, wherein the first coordinate position is a coordinate position of the substrate where the first light reflectance abrupt change is measured, and the second coordinate position is a coordinate position of the substrate where the second light reflectance abrupt change is measured, and a second distance calculating unit to calculate a distance between the first position and the second position according to the first coordinate position and the second coordinate position.

Alternatively, the detection method further includes providing data processing device, the data processing device including an information generating unit for recording the distances at different positions acquired from measurement results of different preset paths and generating a corresponding data file.

Alternatively, the data processing device further includes an alarm unit for alarming if the distance exceeds a preset value range.

Alternatively, the substrate is an array substrate, and the edge of the display area is the edge of the outermost gate line on the array substrate facing away from the center of the array substrate or the edge of the outermost data line on the array substrate facing away from the center of the array substrate.

The detection apparatus of the display panel component provided by the present disclosure, using the light reflectance change of the first position and the light reflectance change of the second position to calculate the distance between the two positions, can not only realize the automatic detection of the coating effect of the alignment film and improve production capacity, but also can improve the measurement accuracy to solve errors caused by artificial measurements.

### BRIEF DESCRIPTION OF THE DRAWINGS

FIG. 1 is a schematic view of a detection apparatus of a display panel component provided in an embodiment of the present disclosure;

FIG. 2 is a schematic view of an array substrate provided in an embodiment of the present disclosure;

FIG. 3 is an enlarged schematic view of the portion in the dashed box in FIG. 2;

FIG. 4 is a schematic view of an alignment film coating detection of the array substrate in FIG. 3;

FIG. 5 is a schematic view of a reflectance change obtained by the detection of the array substrate in FIG. 3; and

FIG. 6 is a schematic view of a detection apparatus of a display panel component according to an embodiment of the present disclosure.

### DETAILED DESCRIPTION

The specific mode for carrying out the present disclosure will be described below in further detail in conjunction with the accompanying drawings and embodiments. It should be known that the embodiments described below merely relate to some embodiments of the present disclosure, rather than limiting the present disclosure. Those of ordinary skill in the art may further obtain other drawings according to these drawings without creative work.

As used herein and in the appended claims, the singular form of a word includes the plural, and vice versa, unless the context clearly dictates otherwise. Thus, the references “a”, “an”, and “the” are generally inclusive of the plurals of the respective terms. Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. Where used herein the term “examples,” particularly when followed by a listing of terms is merely exemplary and illustrative, and should not be deemed to be exclusive or comprehensive.

FIG. 1 is a schematic view of a detection apparatus of a display panel component provided in an embodiment of the present disclosure. The detection apparatus of the display panel component includes reflectance measuring device 100 for measuring the light reflectance of the display panel component along a preset path, the preset path passing through a first position and a second position. In one embodiment, the first position and the second position are the edge of a display area on a substrate and the edge of an alignment film, respectively.

Distance measuring device 200 for acquiring the distance between the first position and the second position (in one embodiment, the edge of the display area and the edge of the alignment film) according to the measured data of the reflectance measuring device.

The detection apparatus of the display panel component provided by the embodiment of the present disclosure, using the light reflectance change at the first position (for example, the edge of the display area) and the light reflectance change at the second position (for example, the edge of the alignment film) to calculate the distance between the two positions, can not only realize the automatic detection of the coating effect of the alignment film and improve production capacity, but also can improve the measurement accuracy to solve errors caused by artificial measurements.

In one embodiment, the display panel component is a substrate coated with an alignment film, and the detection apparatus is an alignment film coating detection apparatus. It is to be noted that the display panel component is not limited only to a substrate coated with an alignment film, but may also include other display panel components. The following exemplary description is given by taking a display panel component which is a substrate coated with an alignment film as an example.

Alternatively, the reflectance measuring device 100 may select a path perpendicular to the edge of the display area as a preset path for measurement.

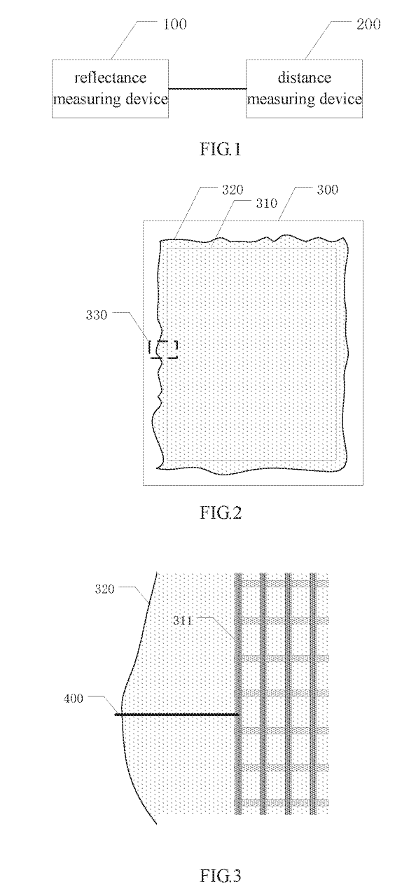

For example, a plurality of criss-crossed gate lines and data lines are provided on an array substrate and a display area is formed on the array substrate by the plurality of criss-crossed gate lines and data lines. Thus, for the display area on the array substrate which is for displaying, the edge thereof is the edge of the outermost gate line facing away from the center of the array substrate as well as the edge of the outermost data line facing away from the center of the array substrate. Besides, since the gate lines and the data lines are usually made of metal materials having a light transmittance of almost zero, such as aluminum, neodymium or molybdenum, when an alignment film 320 is formed on a display area 310 of an array substrate 300 as shown in FIG. 2, three areas with large reflectance differences, an area where no metal line (gate line or data line) is provided and no alignment film is covered, an area where an alignment film is covered only and no metal line is provided and an area where an alignment film is covered and metal lines are provided, respectively, can be formed on the array substrate, and the reflectance of the three areas is sequentially increased. The distance between the edge of the display area 310 and the edge of the formed alignment film 320 can be measured by using the light reflectance difference of the above three areas.

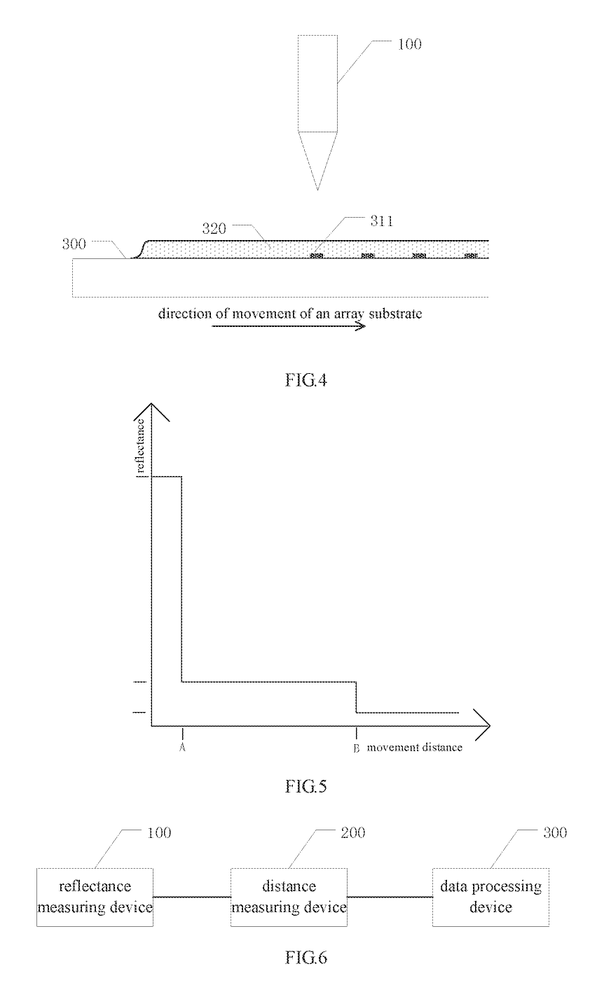

FIG. 3 is an enlarged schematic view of the portion in the dashed box 330 in FIG. 2. As shown in FIG. 3, the reflectance can be measured along the path 400 of the vertically outermost data line 311. The starting point of the measurement may be a position on the data line 311, and by controlling the relative movement of the reflectance measuring device and the array substrate, the reflectance of a plurality of positions on the path 400 may be measured. For example, the reflectance measuring device may be placed above the outermost data line 311 as shown in FIG. 4 to control the array substrate to move in a direction perpendicular to the data line 311 (e.g., at a constant speed). During the course of the movement, the reflectance measuring device (e.g., at equal time intervals) measures the reflectance and sends the measured reflectance to the distance measuring device.

The following exemplary description will be given by example of the array substrate moving at a constant speed and the reflectance measuring device sending data at equal time intervals. The distance measuring device records the position of the array substrate or the time for the movement at a constant speed corresponding to each reflectance data. During the course of the measurement, the currently measured reflectance can be compared with the last measured reflectance. If the difference between the two exceeds a preset value, the occurrence of a reflectance abrupt change may be considered. For example, the coordinate data obtained by recording the moving distance of the array substrate is shown in FIG. 5.

As shown in FIG. 5, during the course of the movement of the array substrate, a first-time reflectance abrupt change occurs when the moving distance is A, and a second-time reflectance abrupt change occurs when the moving distance is B. From the above analysis, it can be seen that when the moving distance of the array substrate is A, the position to measure the reflectance is the edge of the data line 311, and when the moving distance is B, the position to measure the reflectance is the edge of the alignment film. The distance between the edge of the display area 310 at the position and the edge of the formed alignment film 320 can be obtained by subtracting A from the distance B. It should be noted that the reflectance in FIG. 5 is only three straight lines exemplarily, and the straight lines can also be non-straight lines in a reasonable fluctuation range.

In the present embodiment, the reflectance measuring device is used for measuring the light reflectance on the substrate, which may include the following:

A light emitting unit for emitting incident light to a position on the preset path;

A light receiving unit for receiving reflected light from the position on the preset path; and

A light analyzing unit for obtaining a light reflectance of the position on the preset path according to the incident light and the reflected light.

For example, the light emitting unit may be an emission probe having a built-in light source. A light reflectance can be obtained in such a way that the light emitting unit emits incident light, the light receiving unit receives the reflected light, and the light analyzing unit compares the reflected light with the incident light.

Alternatively, the alignment film coating detection apparatus further includes a microscope lens in order to further facilitate the manual control of the position to test the reflectance. For example, the reflectance measuring device and the microscope lens may be integrated into a composite lens, and the light emitting unit may be integrated in the microscope lens.

Wherein, in order to test the light reflectance of a plurality of positions on the preset path, it is possible to control the reflectance measuring device or the array substrate to move so that the two move relative to each other. For example, a moving mechanism may be provided through which the substrate is controlled to move (e.g., at a constant speed) so that the reflectance measuring device measures the light reflectance of a plurality of positions on the preset path.

Wherein, in the present disclosure, the distance measuring device may calculate the distance between the edge of the display area and the edge of the alignment film by collecting different types of data. For example, it may record the time for the movement of the array substrate (e.g., at a constant speed) corresponding to the measurement of each reflectance data, and the distance measuring device includes a timing unit for recording a first time and a second time. The first time is the time when a first light reflectance abrupt change is measured (i.e., the time of passing through the first position), and the second time is the time when a second light reflectance abrupt change is measured (i.e., the time of passing through the second position). In one embodiment, the first light reflectance abrupt change occurs at the edge of the display area and the second light reflectance abrupt change occurs at the edge of the alignment film.

A first distance calculating unit for calculating a distance between the edge of the display area and the edge of the alignment film according to the first time, the second time, and the moving speed (e.g., a constant speed) of the substrate.

In addition, by establishing a (X, Y) coordinate system in advance, the distance measuring device may also record the position of the array substrate corresponding to the measurement of each reflectance data, and the distance measuring device includes a position acquiring unit for recording a first coordinate position and a second coordinate position, wherein the first coordinate position is a coordinate position of the substrate where the first light reflectance abrupt change is measured, and the second coordinate position is a coordinate position of the substrate where the second light reflectance abrupt change is measured. In one embodiment, the first light reflectance abrupt change occurs at the edge of the display area and the second light reflectance abrupt change occurs at the edge of the alignment film.

A second distance calculating unit for calculating a distance between the first position and the second position according to the first coordinate position and the second coordinate position. In one embodiment, the second distance calculating unit is used to calculate the distance between the edge of the display area and the edge of the alignment film.

FIG. 6 is a schematic view of a detection apparatus of another display panel component provided in an embodiment of the present disclosure. The detection apparatus of the display panel component includes reflectance measuring device 100 for measuring the light reflectance along the preset path, the present path passing through the first position and the second position. In one embodiment, the reflectance measuring device 100 is used to measure the light reflectance on the preset path on the substrate coated with the alignment film, the preset path being perpendicular to the edge of the display area on the substrate and passing through the edge of the display area and the edge of the alignment film.

The detection apparatus also includes distance measuring device 200 for acquiring a distance between the first position and the second position according to the measured data of the reflectance measuring device. In one embodiment, the distance measuring device 200 is used to acquire the distance between the edge of the display area and the edge of the alignment film according to the light reflectance detected by the reflectance measuring device.

The detection apparatus further includes a data processing device 300 including an information generating unit for recording the distance at different positions acquired from different measured results of the detection of light reflectance on different preset paths and generating a corresponding data file. For example, for the array substrate shown in FIG. 2, the upper side edge, the lower side edge, the left side edge, and the right side edge may be separately detected, and for each side edge, the detected preset path may be located near the center line of the array substrate.

Alternatively, the data processing device further includes an alarm unit for alarming if the distance exceeds a preset value range. For example, for the array substrate, the preset value range may be from 0.4 mm to 1.0 mm.

For example, for the array substrate shown in FIG. 2, a preset value range is first set for each of the upper side edge, the lower side edge, the left side edge, and the right side edge, and then each side edge is detected. During the course of the detection, for each side edge, if the measured data does not exceed the corresponding preset value range, continue to detect other edges, if the measured data exceeds the corresponding preset value range, alarm through the alarm unit, and then continue to detect other edges after the user confirms the reset. After the completion of the data test of all the edges, a corresponding data file is generated, for example, an EXCEL document may be generated.

The present disclosure provides a detection apparatus of a display panel component and a detection method of a display panel component. In one embodiment, the display panel is a liquid crystal display panel, and the display panel component is a substrate coated with an alignment film. This embodiment provides an alignment film coating detection apparatus that utilizes a light reflectance change at the edge of the display area and a reflectance change at the edge of the alignment film to calculate the distance between the two edges. Embodiments of the disclosure can not only can realize the automatic detection of the coating effect of the alignment film and improve the production capacity, but also can improve the measurement accuracy and solve the errors caused by the artificial measurement. It will be appreciated by those skilled in the art that the display panel component of the present disclosure includes not only the substrate coated with the alignment film but also other display panel components.

The unit or module described herein may be implemented as a combination of a processor and a memory, wherein the processor executes a program stored in the memory to implement the functionality of the corresponding unit or module. The unit or module described herein may be implemented in a hardware implementation, including application specific integrated circuits (ASICs), field programmable gate arrays (FPGAs), and the like.

The above embodiments are merely illustrative of the present disclosure and are not intended to be limiting of the present disclosure, and various changes and modifications may be made by those of ordinary skill in the art without departing from the spirit and scope of the present disclosure. Therefore all the equivalent technical solutions are also within the scope of the present disclosure, and the scope of patent protection of the present disclosure should be defined by the claims.

1. A detection apparatus for a display panel component comprising:
a reflectance measuring device for measuring a light reflectance of the display panel component along a preset path, the preset path passing through a first position and a second position; and
a distance measuring device for acquiring a distance between the first position and the second position according to measured data of the reflectance measuring device, wherein there is a measured light reflectance abrupt change in the first position and the second position, respectively.

2. The detection apparatus according to claim 1, wherein the display panel component is a substrate having an alignment film and a display area, wherein the first position is an edge of the display area, and the second position is an edge of the alignment film.

3. The detection apparatus according to claim 2, wherein the reflectance measuring device comprises:
a light emitting unit for emitting incident light to a position on the preset path;
a light receiving unit for receiving reflected light from the position on the preset path; and
a light analyzing unit for obtaining a light reflectance of the position on the preset path according to the incident light and the reflected light.

4. The detection apparatus according to claim 3, further comprising a microscope lens.

5. The detection apparatus according to claim 4, wherein the light emitting unit is integrated in the microscope lens.

6. The detection apparatus according to claim 2, further comprising a moving mechanism for controlling a movement of the substrate.

7. The detection apparatus according to claim 6, wherein the distance measuring device comprises:
a timing unit for recording a first time and a second time, wherein the first time is the time when a first light reflectance abrupt change is measured, and the second time is the time when a second light reflectance abrupt change is measured; and
a first distance calculating unit for calculating a distance between the first position and the second position according to the first time, the second time, and the moving speed of the substrate.

8. The detection apparatus according to claim 6, wherein the distance measuring device comprises:
a position acquiring unit for recording a first coordinate position and a second coordinate position, wherein the first coordinate position is a coordinate position of the substrate where a first light reflectance abrupt change is measured, and the second coordinate position is a coordinate position of the substrate where a second light reflectance abrupt change is measured; and
a second distance calculating unit for calculating a distance between the first position and the second position according to the first coordinate position and the second coordinate position.

9. The detection apparatus according to claim 2, further comprising a data processing device comprising an information generating unit for recording the distance at different positions acquired from different measured data of the preset path and generating a corresponding data file.

10. The detection apparatus according to claim 9, wherein the data processing device further comprises an alarm unit for alarming if the distance exceeds a preset value range.

11. The detection apparatus according to claim 2, wherein the substrate is an array substrate, and the edge of the display area is the edge of the outermost gate line on the array substrate facing away from the center of the array substrate and the edge of the outermost data line on the array substrate facing away from the center of the array substrate.

12. A method for detecting a display panel component, comprising:
providing reflectance measuring device;
measuring a light reflectance of the display panel component along a preset path, the preset path passing through a first position and a second position; and
providing distance measuring device;
acquiring a distance between the first position and the second position according to the measured data of the reflectance measuring device, wherein there is a measured light reflectance abrupt change in the first position and the second position, respectively.

13. The method according to claim 12, wherein the display panel component is a substrate coated with an alignment film, the first position is an edge of a display area on the substrate, and the second position is an edge of the alignment film.

14. The method according to claim 13, wherein the reflectance measuring device comprises:
a light emitting unit to emit the incident light to a position on the preset path;
a light receiving unit to receive the reflected light from the position on the preset path; and
a light analyzing unit to obtain a light reflectance at the position on the preset path according to the incident light and the reflected light.

15. The method according to claim 14, further comprising providing a moving mechanism to control a movement of the substrate.

16. The method according to claim 15, wherein the distance measuring device comprises:
a timing unit for recording a first time and a second time, wherein the first time is the time when a first light reflectance abrupt change is measured, and the second time is the time when a second light reflectance abrupt change is measured; and
a first distance calculating unit to calculate a distance between the first position and the second position according to the first time, the second time, and the moving speed of the substrate.

17. The method according to claim 16, wherein the distance measuring device further comprises:
a position acquiring unit to record a first coordinate position and a second coordinate position, wherein the first coordinate position is a coordinate position of the substrate where a first light reflectance abrupt change is measured, and the second coordinate position is a coordinate position of the substrate where a second light reflectance abrupt change is measured; and
a second distance calculating unit to calculate a distance between the first position and the second position according to the first coordinate position and the second coordinate position.

18. The method according to claim 17, further comprising providing data processing device, the data processing device comprising an information generating unit for recording the distance at different positions acquired from measurement results of different preset paths and generating a corresponding data file.

19. The method according to claim 18, wherein the data processing device further comprises an alarm unit for alarming if the distance exceeds a preset value range.

20. The method according to claim 13, wherein the substrate is an array substrate, and the edge of the display area is the edge of the outermost gate line on the array substrate facing away from the center of the array substrate and the edge of the outermost data line on the array substrate facing away from the center of the array substrate.
